(19) United States
(12) Patent Application Publication
(10) Pub. No.: US 2025/0056180 A1
(43) Pub. Date: Feb. 13, 2025

(54) WEARABLE SYSTEM FOR SPATIAL AUDIO DETECTION WITH ALERTING ELEMENTS FOR DETECTION OF POTENTIALLY DANGEROUS EVENTS

(71) Applicant: Microchip Technology Incorporated, Chandler, AZ (US)

(72) Inventors: Gheorghe Turcan, Bucharest (RO); Grig Barbulescu, Rosu-Chiajna (RO); Alexandru-loan-Cristian Sabiuta, Filispestii de Padure (RO)

(73) Assignee: Microchip Technology Incorporated, Chandler, AZ (US)

(21) Appl. No.: 18/513,909

(22) Filed: Nov. 20, 2023

Related U.S. Application Data
(60) Provisional application No. 63/531,861, filed on Aug. 10, 2023.

(51) Int. Cl. H04S 7/00; G08B 29/18

(52) U.S. Cl. CPC H04S 7/303; G08B 29/18; H04S 2400/11

(57) ABSTRACT

A system includes a wearable device, a plurality of sound sensors installed in the wearable device, an alerting element installed in the wearable device, and a controller coupled to the plurality of sound sensors and the alerting element. The controller receives a signal indicative of a sound detected by at least one of the plurality of sound sensors, determines whether the sound indicates the presence of a potentially dangerous event, determines a direction of the sound based on the received signal indicative of the sound, if the sound indicates the presence of the potentially dangerous event, activate the alerting element; and if the sound does not indicate the presence of the potentially dangerous event, not activate the alerting element.

### PRIORITY

This application claims priority to U.S. Provisional Patent Application No. 63/531,861, filed Aug. 10, 2023, the contents of which are hereby incorporated in their entirety.

### TECHNICAL FIELD

The present disclosure relates to systems and methods for providing spatial audio detection and haptic feedback to warn of a potentially dangerous event.

### BACKGROUND

As a person moves about their environment, they may encounter various hazards and life-threatening situations. The person may receive warnings of the hazards through audio signals (e.g., sirens, alarms, or verbal warnings). Hearing impaired individuals manage to orient themselves in space quite well, but they have difficulties in observing and reacting quickly to dangers around them because they may have limited or no ability to detect such audio warnings. When the source of the hazard is outside of the individual's field of view, the hearing-impaired individual may have no indication of the presence of the hazard.

Thus, there is a need for improved systems and methods for providing information about potentially dangerous events in the proximity of a hearing impaired person, for which an audio warning is provided, in a convenient and effective manner.

### SUMMARY

Examples of the present disclosure provide systems for providing spatial audio detection and tactile feedback to users of the system. According to one example, a system includes a wearable device, a plurality of sound sensors installed in the wearable device, an alerting element installed in the wearable device, and a controller coupled to the plurality of sound sensors and the alerting element. The controller receives a signal indicative of a sound detected by at least one of the plurality of sound sensors, determines whether the sound indicates the presence of a potentially dangerous event, determines a direction of the sound based on the received signal indicative of the sound, if the sound indicates the presence of the potentially dangerous event, activate one or more of the alerting element; and if the sound does not indicate the presence of the potentially dangerous event, not activate the alerting element.

According to another example, a method includes receiving a signal indicative of a sound detected by at least one of the plurality of sound sensors; determining whether the sound indicates the presence of a potentially dangerous event; determining a direction of the sound based on the received signal indicative of the sound; if the sound indicates the presence of the potentially dangerous event, activating an alerting element in a wearable device; and if the sound does not indicate the presence of the potentially dangerous event, not activating the alerting element in the wearable device.

According to a further example, an apparatus includes a sound sensor interface; an alerting element interface; and a controller. The controller receives a signal indicative of a sound detected by at least one of a plurality of sound sensors in a wearable device; determines whether the sound indicates the presence of a potentially dangerous event; determines a direction of the sound based on the received signal indicative of the sound; if the sound indicates the presence of the potentially dangerous event, activate an alerting element in the wearable device; and if the sound does not indicate the presence of the potentially dangerous event, not activate the alerting element in the wearable device.

### BRIEF DESCRIPTION OF THE DRAWINGS

Example aspects of the present disclosure are described below in conjunction with the figures, in which:

FIGS. 1A and 1B are schematic diagrams of an example system for providing spatial audio detection and tactile feedback, according to examples of the present disclosure;

FIG. 2 is a schematic diagram of an example network of sound sensors, according to examples of the present disclosure;

FIG. 3 is a schematic diagram of an example network of alerting elements, according to examples of the present disclosure;

FIG. 4 is an illustration of an example system for providing spatial audio detection and tactile feedback, according to examples of the present disclosure;

FIG. 5 is a flow chart of the operation of an example system for providing spatial audio detection and tactile feedback, according to examples of the present disclosure; and

FIG. 6 is an example graph of the operation of an example system for providing spatial audio detection and tactile feedback, according to examples of the present disclosure.

It should be understood the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

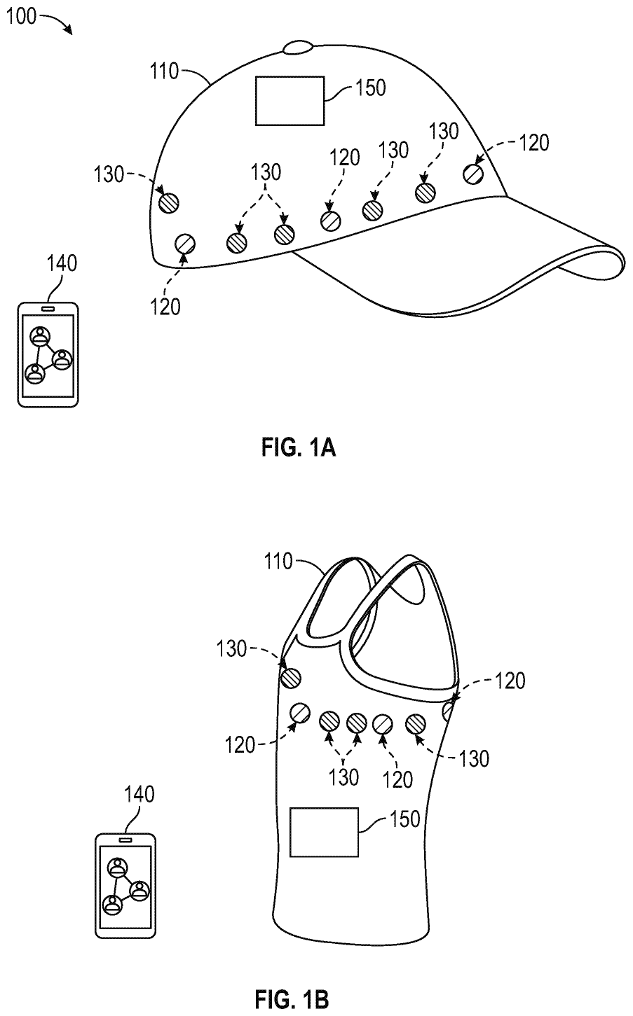

FIG. 1A is a schematic diagram of an example system 100 for providing spatial audio detection and tactile feedback, according to examples of the present disclosure. System 100 includes wearable device 110, sound sensors 120, one or more alerting elements 130, device 140, and controller 150. System 100 implements a method to identify potentially dangerous events, for which an audio warning is provided, in the proximity of a hearing impaired person, and alert the person using alerting elements embedded in a wearable device. By using a device that creates 3D-mapping of sound into non-audible alerts (e.g., vibrations and/or visible alerts) in a case where the sounds are considered indicative of a potentially dangerous event, the awareness of hearing impaired people is increased. System 100 can be implemented using dedicated hardware and software.

Wearable device 110 is a device worn by the user. While it is illustrated in FIG. 1A as a hat, wearable device 110 may be any device worn by a user such as a bracelet, glasses, ring, vest, headband, or other wearable device that permits spatial direction notification. For example, FIG. 1B illustrates wearable device 110 as a vest worn on the user's torso. Because wearable device 110 is worn by the user, it is easy for a user to interact with it. In some embodiments, wearable device 110 may be a combination of multiple devices. For example, wearable device 110 may be made of one device containing sound sensors 120 and another device containing one or more alerting elements 130, wherein the devices are in communication with each other. As another example, wearable device 110 may be formed of one device containing a subset of sound sensors 120 and one or more alerting elements 130 and another device containing another subset of sound sensors 120 and one or more alerting elements 130.

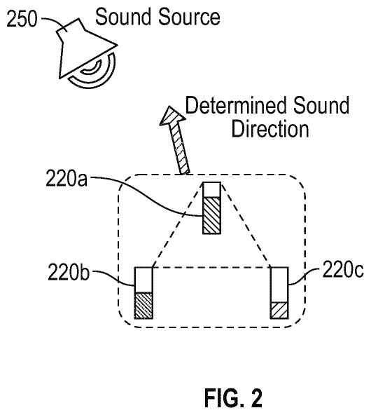

Sound sensors 120 are formed of any type of audio sensor, decibel meter, or sound level sensor. For example, each sound sensor 120 may be a microphone with corresponding processing circuitry. As another example, sound sensors 120 may be a network of microphones, respectively coupled to a single processing circuit, such as controller 150. Wearable device 110 includes at least three sound sensors 120 to create a network of sensors that can be used to identify the direction of the sounds. During operation, sound sensors 120 monitor for sounds from the environment surrounding the user. Sound sensors 120 are placed in wearable device 110 such that sound sensors 120 provide 360° coverage around wearable device 110. Signals indicative of sounds detected by sound sensors 120 are communicated to controller 150. Controller 150 analyzes the signals and, if the sounds are considered indicative of a potentially dangerous event, system 100 instructs the one or more alerting element 130 to generate tactile feedback to the user. The placement and operation of sound sensors 120 are described in more detail with respect to FIG. 2.

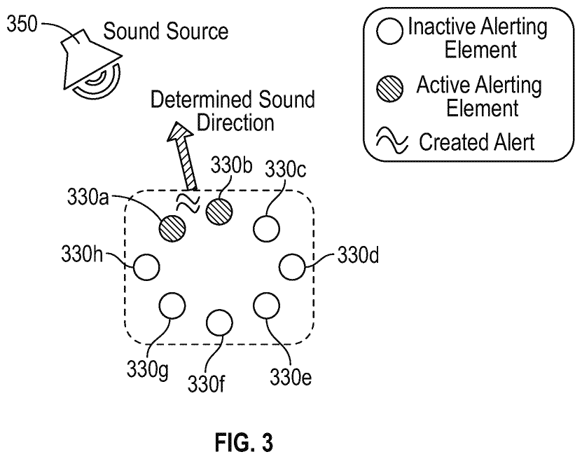

Alerting elements 130 are formed of any type of device that can provide tactile feedback to a user, such as by using vibration, light, temperature, or any other suitable non-auditory feedback. Alerting elements 130 are coupled to controller 150. When system 100 instructs one or more alerting element 130 to generate tactile feedback, the one or more alerting elements 130 may activate to alert the user of a potential danger. For example, the one or more alerting elements 130 may vibrate, illuminate, and/or change temperature in response to the instruction. Alerting elements 130 are placed in wearable device 110 to form a network of stimulating components that generate a haptic feedback that are indicative of the presence, direction, and/or intensity of the sound. Thus, alerting elements 130 provide information to the user of wearable device 110 as to the presence, direction, and/or intensity of the sound detected by one or more sound sensor 120. For example, a subset of alerting elements 130 may vibrate to alert the user, which subset of alerting elements 130 may correspond to the direction of the sound indicative of the potentially dangerous event detected by sound sensors 120. In some embodiments, the intensity level at which alerting elements 130 vibrate corresponds to the volume of the sound detected by sound sensors 120. In other embodiments, a subset of alerting elements 130 may light up to indicate the presence of a potentially dangerous event and may blink at an intensity level corresponding to the volume of the sound detected by sound sensors 120. In yet another embodiment, a subset of alerting elements 130 may change temperature (e.g., heat up or cool down) to indicate the presence of a potentially dangerous event and the amount of the temperature change may correspond to the volume of the sound detected by sound sensors 120. The correspondence between the volume of the detected sound and the intensity level of the one or more alerting elements 130 may be linear, logarithmic, or a combination thereof. The placement and operation of alerting elements 130 are described in more detail with respect to FIG. 3.

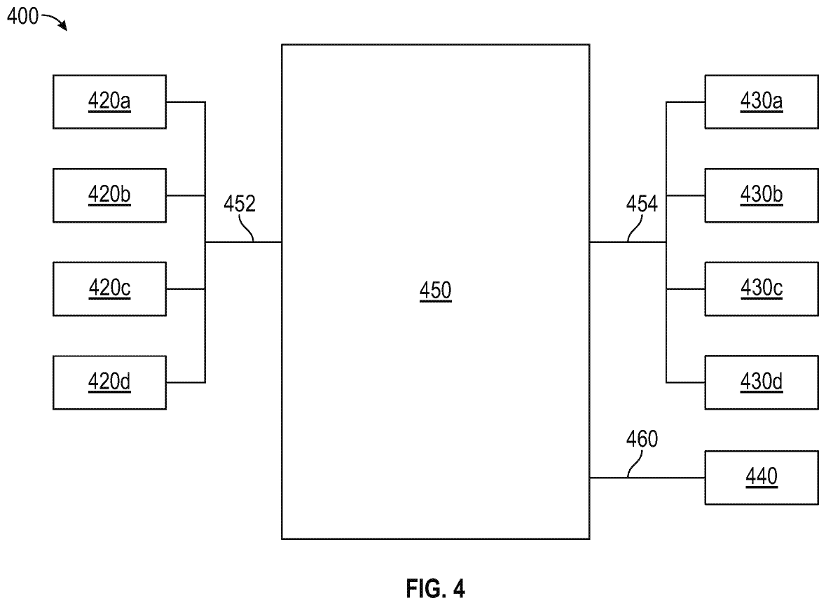

System 100 may include controller 150 in wearable device 100 that controls the operation of wearable device 110, sound sensors 120, and/or alerting elements 130 in conjunction with, or independently of, the software application executing on device 140, as described in more detail with respect to FIG. 4. In addition to controller 150, system 100 may include device 140 to provide a user interface to allow a user to calibrate, configure, and/or control the operation of wearable device 110, sound sensors 120, and/or alerting elements 130. Device 140 may be any device comprising a processor capable of executing a software application. For example, device 140 may be a mobile phone, tablet computer, laptop computer, personal computer, or PDA.

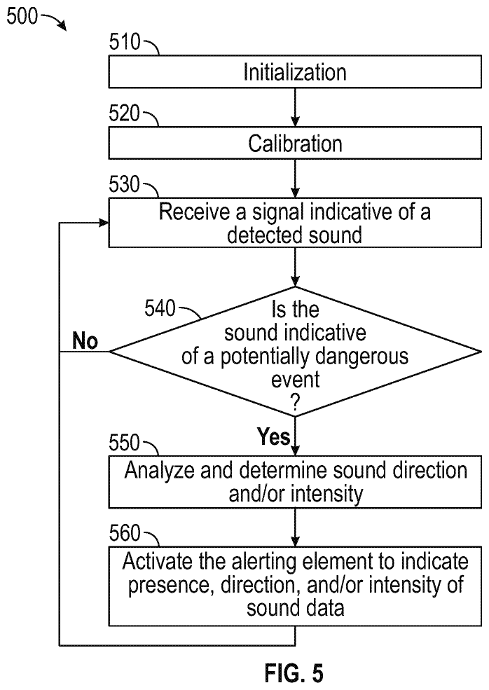

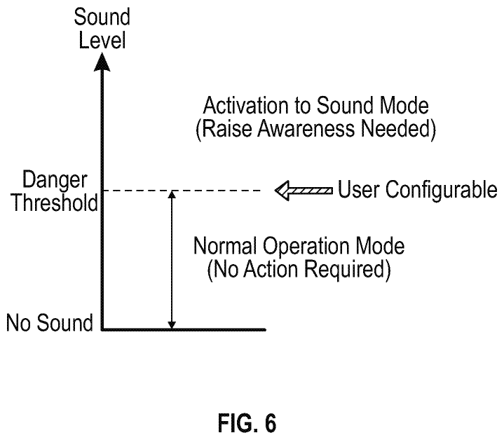

The software application executing on device 140 may communicate with controller 150 to calibrate sound sensors 120 and/or alerting elements 130 and adjust parameters associated with sound sensors 120 and/or alerting elements 130 such as adjusting the “danger threshold” and the maximum intensity of the haptic feedback provided by one or more alerting elements 130. Additionally, in some embodiments, system 100 monitors environmental sounds and controller 150 analyzes these sounds to determine whether the sounds exceed the “danger threshold” or if certain keywords indicating danger are recognized. For example, controller 150 analyzes the acquired sounds and determines, based on certain criteria, if it is considered indicative of the potentially dangerous event. If so, controller 150 generates haptic or other feedback by driving respective ones of the one or more altering elements 130 to provide vibrations that are indicative of the intensity and direction of the sounds which exceed the “danger threshold” or of the recognized certain keywords indicating danger. In other embodiments, the software application executing on device 140 analyzes the sounds to determine whether the sounds exceed the “danger threshold” or if certain keywords indicating danger are recognized and generates haptic or other feedback by driving respective ones of the one or more altering elements 130 to provide vibrations that are indicative of the intensity and direction of the sounds which exceed the “danger threshold” or of the recognized certain keywords indicating danger. The operation of the software application and/or controller 150, the danger threshold, and keyword recognition are described in more detail with respect to FIGS. 5 and 6.

FIG. 2 is a schematic diagram of an example network of sound sensors included in wearable device 110, according to examples of the present disclosure. The embodiment shown in FIG. 2 includes three sound sensors 220a-220c, but wearable device 110 may include more than three sound sensors 220.

Sound sensors 220 are arranged in an equilateral triangle configuration with three sensors. Each sound sensor 220 has a primary contribution for a sector of 120° around wearable device 110. In embodiments where wearable device 110 includes more than three sound sensors 220, each sound sensor 220 has a primary contribution for a smaller sector around wearable device 110. For example, if wearable device 110 includes six sound sensors 220, each sound sensor 220 may provide primary contribution for sounds in a 60° sector around wearable device 110. Increasing the number of sound sensors 220 will determine a smaller sector of primary contribution for respective ones of the sound sensors 220 and improve accuracy.

When detecting sounds, a sound sensor 220 closest to the source of the sound will detect the sound at a higher level than sound sensors 220 further from the source of the sound. For example, in FIG. 2, sound sensor 220a is closest to sound source 250 and detects a higher sound level than sound sensors 220b and 220c. When sounds detected by one sound sensor 220 crosses a user-configurable sound threshold, the data from all sound sensors 220 is analyzed using a software application and/or a controller and the software application and/or controller determines a direction of the detected sound. The software application and/or controller may use computational techniques, such as a multipath compensation and/or keyword recognition techniques, to analyze detected sounds, determine whether the sounds are indicative of a potentially dangerous event, and determine the direction of the source of the potential danger. These techniques are described in more detail with respect to FIGS. 4 and 5.

FIG. 3 is a schematic diagram of an example network of alerting elements included in wearable device 110, according to examples of the present disclosure. The embodiment shown in FIG. 3 includes eight alerting elements 330a-330h, but wearable device 110 may include more or less than eight alerting elements 330.

Once system 100 detects the presence of a sound indicative of a potential danger and the determines the direction of the source of the sound indicative of the potential danger, system 100 activates one or more alerting elements 330 to communicate the presence of the potential danger to the user. The number of alerting elements 330 activated system 100 corresponds to the direction of the source of the sound indicative of the potential danger. For example, in FIG. 3, system 100 determines that sound source 350 indicates the presence of a potential danger. As a result, system 100 determines the direction of sound source 350 and activates alerting elements 330a and 330b which are closest to sound source 350. System 100 does not activate alerting elements 330c-330h. In this way, the user of system 100 can determine that the potential danger is in the direction of the activated alerting elements 330a and 330b.

In some embodiments, the intensity of the activation (e.g., vibration, light blinking, and/or temperature change) of the activated alerting elements 330 corresponds to the volume of sound source 350. For example, the higher the volume of sound source 350, the more intense the activation of activated alerting elements 330. The intensity of the activation of activated alerting elements 330 may be directly proportional to the volume of sound source 350 or may be based on a logarithmic correlation.

FIG. 4 is an illustration of an example system for providing spatial audio detection and tactile feedback, according to examples of the present disclosure. System 400 includes sound sensors 420a-420d which may be similar to sound sensors 120 and 220a-220c described with respect to FIGS. 1A, 1i, and 2. System 400 includes also includes alerting elements 430a-430d which may be similar to sound sensors 130 and 330a-330c described with respect to FIGS. 1A, 1, and 3. System 400 further includes device 440 including a software application executed by device 440. Device 440 may be similar to device 140 described with respect to FIGS. 1A and 1B.

System 400 further includes wearable controller 450. Wearable controller 450 may be implemented by analog circuitry, digital circuitry, application specific integrated circuits (ASIC), field programmable gate arrays (FPGA), reconfigurable logic, programmable logic devices (PLDs), instructions for execution by a processor, or any suitable combination thereof. Wearable controller 450 may be coupled to sound sensors 420a-420d and alerting elements 430a-430d. Specifically, wearable controller 450 may include sound sensor interface 452 to receive data related to sounds detected by one or more sound sensors 420a-420d. Wearable controller 450 may also include alerting element interface 454 to send signals to one or more alerting elements 430a-430d to activate one or more alerting elements 430a-430d in response to the sound detection.

Wearable controller 450 may control the operation of sound sensors 420a-420d and alerting elements 430a-430d by receiving sound measurements from sound sensors 420a-420d, analyzing the sound measurements, determine the direction of the sound, and generating a signal to activate alerting elements 430a-430d, as described in further detail with respect to FIG. 5.

Wearable controller 450 may communicate with device 440 via communications link 460. Communications link 460 may be any suitable wired or wireless communications protocol such as an internet protocol, a mobile phone protocol, a wireless local area network (W-LAN) protocol (such as the IEEE 802.11 protocol), or various short-range wireless communication link agreements, such as a Bluetooth, NFC, or ZigBee. A user of the wearable device containing sound sensors 420a-420d and alerting elements 430a-430d may interact with device 440 to calibrate, configure, and/or control system 400 as described in more detail with respect to FIG. 5.

FIG. 5 is a flow chart of the operation of an example system for providing spatial audio detection and tactile feedback, according to examples of the present disclosure. Method 500 may be implemented using a wearable controller, such as wearable controller 450, a software application executed by device 140 or device 440, any suitable combination thereof, or any other system operable to implement method 500. Although examples have been described above, other variations and examples may be made from this disclosure without departing from the spirit and scope of these disclosed examples.

Method 500 begins at step 510 where method 500 initializes a system for providing spatial audio detection and tactile feedback, such as system 100 and/or system 400. Initialization may include powering up the sound sensors and alerting elements of the system, such as sound sensors 120, 220, and/or 420 and alerting elements 130, 330, and/or 430.

Method 500 proceeds to step 520 to calibrate the system. Calibration may include calibrating the sound sensors and alerting elements, such as mapping the sound sensors to alerting elements so that the system activates the alerting elements based on sounds detected. Calibration may also include user customization, such as setting the activation intensity, danger threshold, sound patterns or volume levels that trigger an alert, and environmental profiles. For example, the user may select to only be alerted to sounds above a certain volume level. As another example, the user may select to be alerted only when the system recognizes that the sound is a police or ambulance siren. In addition, the user may create different environmental profiles corresponding to different ambient noise situations. For example, the user may have a work profile, a traffic profile, and a park profile, where the volume threshold for the traffic profile is higher than the volume threshold for the park profile.

Method 500 proceeds to step 530 where method 500 receives a signal indicative of a sound detected using the sound sensors. At step 540, method 500 determines whether the detected sound data is indicative of the presence of a potentially dangerous event. The determination may be made based on the detected sound data exceeding a threshold (e.g., exceeding a volume level) or pattern recognition. For example, method 500 may use pattern recognition to determine that the sound is a siren from a police car, an ambulance, or a fire truck. As further examples, method 500 may use pattern recognition to detect sounds from heavy machinery (e.g., a backup alert), sounds from barking dogs, or verbal warnings (e.g., “STOP,” “WAIT,” “FIRE”). In some embodiments, the determination may be made based on a combination of pattern recognition and a threshold. For example, method 500 may determine that the detected sound data is indicative of the presence of a potentially dangerous event if the detected sound is a verbal warning having a volume greater than a threshold. The pattern recognition may be performed using artificial intelligence. The threshold may be customized by the user at step 520.

If the system determines that the sound data is not indicative of the presence of a potentially dangerous event, method 500 returns to step 530 to continue detecting sound data and does not activate the alerting element. If method 500 determines the sound data is indicative of the presence of a potentially dangerous event, method 500 proceeds to step 550. At step 550, method 500 analyzes the sound data and determines the direction and/or intensity of the sound data. Method 500 may make this determination using a multipath compensation technique. Method 500 also determines that the sound data detected by multiple sound sensors corresponds to the same sound so that it can determine the direction of the sound data. For example, method 500 may look for a substantially similar waveform detected by one or more sound sensors and then perform multipath compensation techniques based on the sound data.

At step 560, method 500 activates the alerting elements to provide tactile feedback to the user of the presence, direction, and/or intensity of the captured sound data. By using this system, the user's environmental awareness is increased. Method 500 then returns to step 530 to continue capturing sound data.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

FIG. 6 is an example graph of the operation of an example system for providing spatial audio detection and tactile feedback, according to examples of the present disclosure. FIG. 5 provides further details of method 500.

As described at step 520, the user can configure the threshold based on a decibel level, pattern recognition, or a combination thereof Δt step 540, when the sound captured at step 530 is below the threshold, method 500 operates in normal operation mode, where no alerting elements are active. However, if at step 540 the system determines that the sound is above the threshold, method 500 operates in Activation to Sound mode where the system activates one or more alerting elements to alert the user to the presence, direction, and/or intensity of a potential danger.

Although examples have been described above, other variations and examples may be made from this disclosure without departing from the spirit and scope of these examples.

1. A system, comprising:
a wearable device;
a plurality of sound sensors installed in the wearable device;
an alerting element installed in the wearable device; and
a controller coupled to the plurality of sound sensors and the alerting element, the controller to:
receive a signal indicative of a sound detected by at least one of the plurality of sound sensors;
determine whether the sound indicates the presence of a potentially dangerous event;
determine a direction of the sound based on the received signal indicative of the sound;
if the sound indicates the presence of the potentially dangerous event, activate the alerting element; and
if the sound does not indicate the presence of the potentially dangerous event, not activate the alerting element.

2. The system of claim 1, wherein the alerting element comprises a plurality of alerting elements, and activating the alerting element comprises activating one or more of the plurality of alerting elements to indicate a direction of the sound.

3. The system of claim 1, wherein activating the alerting element comprises indicating an intensity of the sound.

4. The system of claim 1, wherein the wearable device is worn on a user's head or a user's torso to permit spatial direction notification.

5. The system of claim 1, wherein the plurality of sound sensors includes at least three sound sensors, respective ones of the sound sensors having primary detection contribution for a sector about the wearable device.

6. The system of claim 1, wherein determining whether the sound indicates the presence of a potentially dangerous event is based on detecting a keyword.

7. The system of claim 1, wherein determining a direction of the sound based on data from the plurality of sound sensors comprises using a multipath compensation technique.

8. A method, comprising:
receiving a signal indicative of a sound detected by at least one of a plurality of sound sensors;
determining whether the sound indicates the presence of a potentially dangerous event;
determining a direction of the sound based on the received signal indicative of the sound;
if the sound indicates the presence of the potentially dangerous event, activating an alerting element in a wearable device; and
if the sound does not indicate the presence of the potentially dangerous event, not activating the alerting element in the wearable device.

9. The method of claim 8, wherein activating the alerting element comprises activating a plurality of alerting elements to indicate a direction of the sound.

10. The method of claim 8, wherein activating the alerting element comprises indicating an intensity of the sound.

11. The method of claim 8, wherein the wearable device is worn on a user's head or a user's torso to permit spatial direction notification.

12. The method of claim 8, wherein the plurality of sound sensors includes at least three sound sensors, respective ones of the at least three sound sensors having primary detection contribution for a sector about the wearable device.

13. The method of claim 8, wherein determining whether the sound indicates the presence of a potentially dangerous event is based on detecting a keyword.

14. The method of claim 8, wherein determining a direction of the sound based on the received signal indicative of the sound comprises using a multipath compensation technique.

15. An apparatus, comprising:
a sound sensor interface;
an alerting element interface; and
a controller to:
receive a signal indicative of a sound detected by at least one of a plurality of sound sensors in a wearable device;
determine whether the sound indicates the presence of a potentially dangerous event;
determine a direction of the sound based on the received signal indicative of the sound; and
if the sound indicates the presence of the potentially dangerous event, activate an alerting element in the wearable device; and
if the sound does not indicate the presence of the potentially dangerous event, not activate the alerting element in the wearable device.

16. The apparatus of claim 15, wherein activating the alerting element comprises activating a plurality of alerting elements to indicate a direction of the sound.

17. The apparatus of claim 15, wherein activating the alerting element comprises indicating an intensity of the sound.

18. The apparatus of claim 15, wherein the plurality of sound sensors includes at least three sound sensors, respective ones of the sound sensors having primary detection contribution for a sector about the wearable device.

19. The apparatus of claim 15, wherein determining whether the sound indicates the presence of a potentially dangerous event is based on detecting a keyword.

20. The apparatus of claim 15, wherein determining a direction of the sound based on data from the plurality of sound sensors comprises using a multipath compensation technique.
